(19) United States
(12) Patent Application Publication
(10) Pub. No.: US 2003/0103161 A1
(43) Pub. Date: Jun. 5, 2003

(54) Reduce size structure of surveillance camera

(76) Inventors: Toshikazu Tatewaki, Sagamihara-shi (JP); Masaomi Iiizumi, Yokohama-shi (JP)

Correspondence Address: LOUIS WOO, LAW OFFICE OF LOUIS WOO, 717 NORTH FAYETTE STREET, ALEXANDRIA, VA, 22314, US

(21) Appl. No.: 10/309,051

(22) Filed: Dec. 4, 2002

(30) Foreign Application Priority Data
Dec. 5, 2001 (JP) 2001-371318

(51) Int. Cl. H04N 5/225

(52) U.S. Cl. 348/375

(57) ABSTRACT

An improved structure of a surveillance camera device is provided which permits the size of the device to be reduced. The camera device consists of a camera unit, a rotary bracket, and a mount body. The rotary bracket is made of an annular plate and retained to be panable by guide rollers installed on a flange of the mount body. The camera unit is retained to be tiltable by the rotary bracket with the bottom thereof disposed within a central opening of the rotary bracket, thereby resulting in a decrease in distance between the flange of the mount body and the top of the camera unit.

### BACKGROUND OF THE INVENTION

1 Technical Field of the Invention

The present invention relates generally to a surveillance camera, and more particularly to a surveillance camera for use with store security, building security, and any other security applications.

2 Background Art

Typical surveillance cameras present an appearance which persons will perceive to be a surveillance camera clearly and gives the impression that they are being watched in order to prevent crimes before happening, but it gives an unpleasant feeling to customers in the store, for example. The surveillance cameras are, thus, unpopular. In order to avoid such a problem, dome-shaped smoky surveillance cameras which are designed not to give people the pressure mentally have become prevalent. Typical surveillance cameras are classified into two types: an automatically angle adjustable type in which a direction of surveillance can be changed from a remote monitor room and an angle fixed type in which a direction of surveillance is fixed upon installation of the camera.

FIGS. 5 and 6 illustrate an internal structure of the angle fixed type of conventional dome-shaped surveillance camera device. The camera unit 100 has an image capturing lens 102, a CCD image sensor, and a circuit substrate which are disposed within a casing 101 and works to convert a captured image into an electrical signal and output it. The casing 101 is retained at a side wall thereof by arms 103a of a holder plate 103. The holder plate 103 is disposed on the bottom of a support plate 104 to be rotatable to yaw the camera unit 100. The support plate 104 has arms 104a and 104b which are supported by upright arms 105a and 105b of a rotary bracket 105 through pins 106 and 107 to be rotatable vertically to tilt the camera unit 100. The rotary bracket 105 has engages at the center thereof a boss 109 of a base plate 108 to be rotatable horizontally to pan the camera unit 100. The base plate 108 is fixed on a body of the camera device (not shown). The camera device has installed therein a main substrate on which a power supply circuit and an image processing circuit are disposed and also has a power cord and a control cord extending outside the camera device for connection with a commercial power supply and an external camera monitor. A smoky dome-shaped resinous cover is installed on the camera device to cover the camera unit 100.

Such a surveillance camera device is usually suspended from a ceiling or installed on a side wall of a building. The installation is achieved by affixing the camera device to the wall temporarily, connecting the power and control cords to the camera device, panning and tilting the camera device while watching the camera monitor, and fixing the camera device in a desired position. In a case where the camera device is installed on the side wall, a vertical direction of a captured image may be inclined after the angle adjustment. The inclination is corrected by yawing the camera unit 100 to stand the image upright. After the direction in which an image is to be captured is determined, the camera device is fixed firmly on the wall.

The above camera device, however, has the drawback in that the rotary bracket 105 is supported at the center thereof rotatably by the base plate 108, and the camera unit 100 is retained rotatably by the upright arms 105a and 105b of the rotary bracket 105, thus resulting in an increased length of the camera unit 100 from the base plate 108 to the top thereof, which makes it difficult to meet the requirements of thickness reduction of the camera device.

### SUMMARY OF THE INVENTION

It is therefore a principal object of the present invention to avoid the disadvantages of the prior art.

It is another object of the present invention to provide an improved structure of a surveillance camera device which allows to reduce the size thereof.

According to one aspect of the invention, there is provided a surveillance camera device which comprises: (a) a camera unit working to capture an image of a surveillance target and output an image signal indicative of the captured image; (b) a rotary bracket made of an annular plate serving to support the camera unit rotatably; (c) rotation guide members placed in contact with a periphery of the rotary bracket to guide rotation of the rotary bracket; and (d) a mount body on which the rotation guide member is mounted. The rotary bracket is, as described above, made of the annular plate and has a central opening. This permits a lower portion of the camera unit to be disposed within the central opening of the rotary bracket, thus resulting in a decrease in distance between the mount body and the top of the camera unit, which leads to a decrease in thickness or size of the surveillance device.

In the preferred mode of the invention, the rotation guide members are implemented by at least one tension roller and a plurality of guide rollers. The installation of the rotary bracket may be achieved easily by pressing the tension roller outward, placing the rotary bracket in contact with the guide rollers, and releasing the tension roller into contact with the periphery of the rotary bracket.

The rotary bracket has disposed thereon a pair of support arms diametrically opposed to each other. The support arms support the camera unit rotatably. This permits the pan angle and tilt angle of the camera unit to be adjusted easily by turning the rotary bracket and the camera unit, respectively.

### BRIEF DESCRIPTION OF THE DRAWINGS

The present invention will be understood more fully from the detailed description given hereinbelow and from the accompanying drawings of the preferred embodiments of the invention, which, however, should not be taken to limit the invention to the specific embodiments but are for the purpose of explanation and understanding only.

In the drawings:

FIG. 1 is an exploded perspective view which shows a surveillance camera device according to the invention;

FIG. 2(a) is a perspective view which shows a camera unit;

FIG. 2(b) is a perspective view which shows a mount body;

FIG. 3 is an exploded view which shows the mount body of FIG. 2(b);

FIG. 4 is an exploded view which shows the camera unit of FIG. 2(a);

FIG. 5 is a perspective view which shows a conventional surveillance camera device; and

FIG. 6 is a perspective view which shows an internal structure of the camera device of FIG. 5.

### DESCRIPTION OF THE PREFERRED EMBODIMENTS

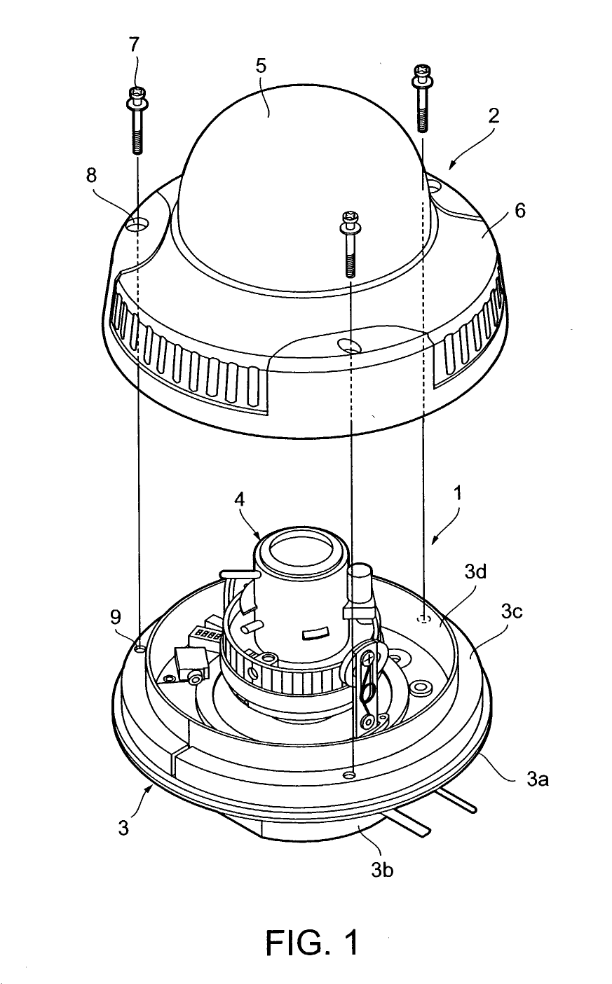

Referring now to the drawings, particularly to FIG. 1, there is shown the angle fixed type of surveillance camera device consisting of a camera assembly 1 and a domed cover assembly 2. In the following discussion, the terms “upper”, “lower”, “vertical”, and “horizontal” are used to refer to the orientation of the surveillance camera device disposed in the orientation shown in FIG. 1.

The camera assembly 1 consists essentially of a mount body 3 and a camera unit 4. The mount body 3 has an upper flange 3a and a lower cylinder 3b. The camera unit 4 is installed on the mount body 3. The flange 3a has an upper annular flat surface. An annular guide 3c is formed on a peripheral portion of the upper surface of the flange 3a. The domed cover assembly 2 is fitted on the periphery of the annular guide 3c. A ring-shaped upright wall 3d is installed as a reinforcement on the upper surface of the flange 3a. The domed cover assembly 2 consists of a dome 5 and a cover 6. The dome 5 is made of a fully smoked polycarbonate resin and has a thickness of approximately 3.5 mm. The installation of the domed cover assembly 2 on the camera assembly 1 is achieved by inserting three screws 7 through mount holes 8 in the cover 6 into screw holes 9 in the guide 3c of the camera assembly 1.

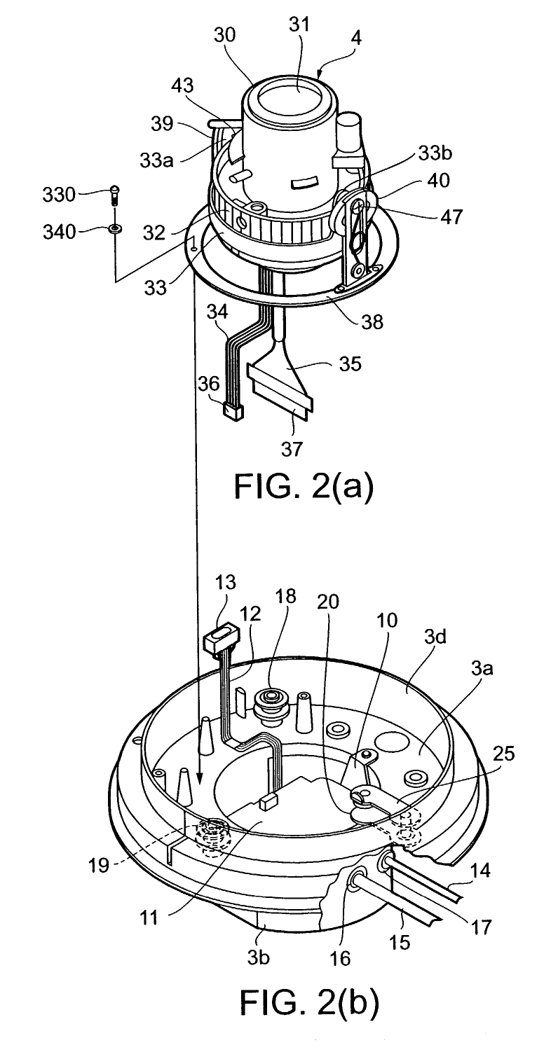

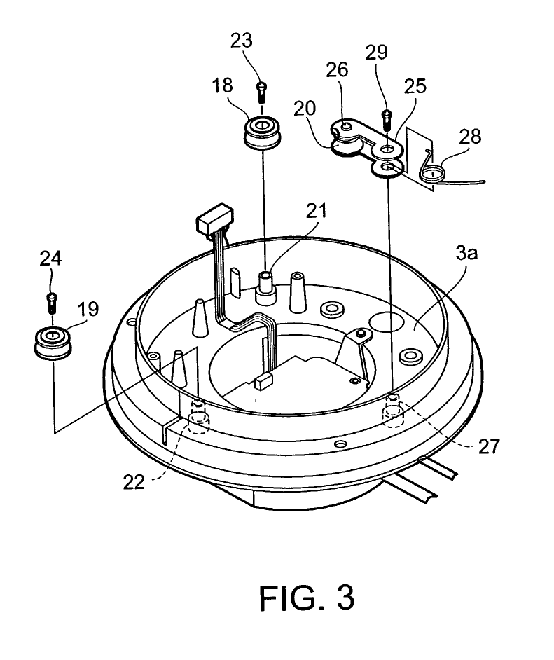

A main circuit substrate 11 is, as clearly shown in FIG. 2(b), installed at sides thereof within the cylinder 3b of the mount body 3 through brackets 10. A variety of adjustment switches 13 is joined to the main circuit substrate 11 through a harness 12. A control cord 14 and a power cord 15 extend from the main circuit substrate 11 outside the cylinder 3b through cord bushings 16 and 17. The control cord 14 is used to transmit a camera output to an external monitor.

Three hourglass-shaped guide rollers 18, 19, and 20 are installed rotatably on the flange 3a at regular intervals inside the reinforcement wall 3d. The guide rollers 18 and 19 are fitted on studs 21 and 22 projecting from the flange 3a and retained by screws 23 and 24, respectively. The guide roller 20 works as a tension roller and installed rotatably by a screw 26 on an end of a lever 25 of a C-shape in cross section. The lever 25 is installed at the other end thereof on a stud 27 on the flange 3a rotatably by a screw 29 and urged by a torsion coil spring 28 inward of the flange 3a in a radius direction.

The camera unit 4, as clearly shown in FIG. 2(a), includes an image capturing lens 31 installed on an upper end of a cylindrical casing 30, a CCD sensor disposed on a focal point within the casing 30, and a circuit substrate on which a camera control circuit is mounted. An adjustment ring 32 which is formed integrally with the casing 30 is fitted at a lower portion thereof in a hollow cylindrical rotary base 33 to be rotatable to adjust a yaw angle of the camera unit 4. Harnesses 34 and 35 extend from the circuit substrate installed within the casing 30 and are joined at ends thereof to connectors 36 and 37 for electrical connections with the main circuit substrate 11 installed in the mount body 3. Upright strips 33a and 33b are formed on diametrically opposed ends of the rotary base 33 and held by support arms 39 and 40 to be swingable. The support arms 39 and 40 extend vertically from a rotary bracket 38. The rotary bracket 38 is supported at a periphery thereof by the guide rollers 18, 19, and 20 of the mount base 3 to be rotatable horizontally or panable.

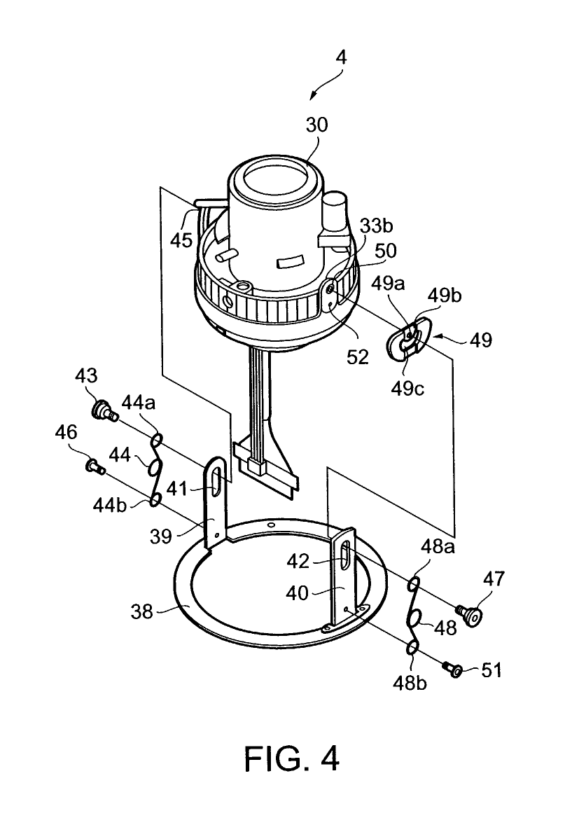

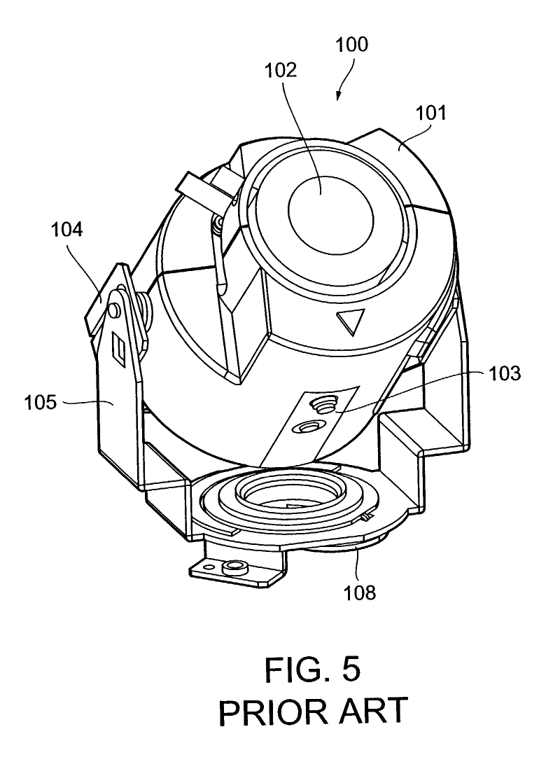

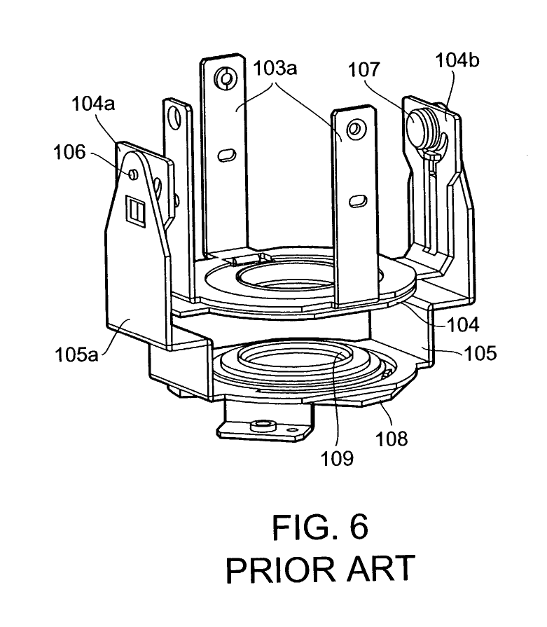

The rotary bracket 38 is, as clearly shown in FIG. 4, made of an annular plate. The upright arm 39 is formed integrally with the annular plate and extends vertically. The upright arm 40 is secured on the periphery of the annular plate through screws. The upright arms 39 and 40 have holes 41 and 42 elongated in a lengthwise direction thereof. An axis screw 43 consisting of an axis portion and a threaded portion is inserted into the elongated hole 41 from outside the upright arm 39 through an upper mount ring 44a of a torsion coil spring 44 and engaged in a screw hole 45 formed in the upright strip 33a of the rotary base 33. A lower mount ring 44b of the torsion coil spring 44 is installed on the support arm 39 of the rotary bracket 38 through a small axis screw 46. Specifically, the upper mount ring 44a and the lower mount ring 44b are hung on the axes of the screws 43 and 46 at a given interval away from each other, thus allowing the casing 30 to tilt to the rotary bracket 38. An axis screw 47 is inserted into the elongated hole 42 from outside the support arm 40 through an upper mount ring 48a of a torsion coil spring 48 and engaged in a screw hole 50 formed in the upright strip 33b of the rotary base 33 through a hole 49a of a tilt plate 49, so that the rotary base 33 or the casing 30 is supported by the rotary bracket 38 to be swingable vertically or tiltable. A lower mount ring 48b of the torsion coil spring 48 is installed rotatably on the support arm 40 of the rotary bracket 38 through a small axis screw 51. The tilt plate 49 has formed therein a vertical groove 49a in which the hole 49a is formed and an arc-shaped horizontal guide hole 49c formed in a lower portion of the vertical groove 49a. The vertical groove 49a has a width substantially identical with that of the support arm 40. The support arm 40 is engaged in the vertical groove 49b of the tilt plate 49 to hold the tilt plate 49 from rotating. A guide pin 52 installed on the upright strip 33b of the rotary base 33 is inserted into the guide hole 49c to be swingable therewithin, thereby defining a tilt angular range within which the rotary base 33 or the casing 30 is tiltable relative to the rotary bracket 38.

The installation of the surveillance camera device will be described below.

First, the connectors 36 and 37 of the camera unit 4 are joined to connectors installed on the main circuit substrate of the mount body 3. Next, the guide roller 20 (i.e., the tension roller) is pressed outward through the lever 25 and kept as it is. The camera unit 4 is put in the mount body 3. The periphery of the rotary bracket 38 of the camera unit 4 are placed in contact with the guide rollers 18 and 19, after which the lever 25 is released to bring the guide roller 20 into contact with the periphery of the rotary bracket 38, so that the rotary bracket 38 is pressed elastically by the torsion coil spring 28 of the guide roller 20, thereby applying a brake to a horizontal rotation of the camera unit 4. This permits the camera unit 4 to be adjusted in a pan angle and held at a desired horizontal angular position. The camera unit 4 is also rotatable vertically about the axis screws 43 and 47, thereby permitting the camera unit 4 to be adjusted in a tilt angle and held at a desired vertical angular position.

Specifically, in the installation of the surveillance camera device on the ceiling or wall of a building, a surveillance orientation toward, for example, an entrance of the building is fixed by adjusting the pan angle and the tilt angle of the camera unit 4. The pan angle is fixed by using a vis(es) 330 and a washer(s) 340, as shown in FIG. 2(a). The tilt angle is fixed by tightening the axis screws 43 and 47. In a case where the surveillance camera unit is installed on a side wall of the building, the adjustment of the pan and tilt angles may cause an image captured by the camera unit 4 to be inclined. This inclination is corrected by turning the adjustment ring 32 of the casing 30 to adjust the yaw angle of the camera unit 4. These adjustments are accomplished by an installation operator while watching the monitor.

As apparent from the above discussion, the rotary bracket 38 serving to support the camera unit 4 to be tiltable is made of a ring-shaped plate and retained at the periphery thereof by the three guide rollers 18, 19, and 20 to be panable. This permits the lower portion of the camera unit 4 to be disposed within the central opening of the rotary bracket 38, thereby resulting in a decrease in distance between the flange 3a of the mount body 3 and the top of the camera unit 4, which leads to a decrease in overall thickness of the surveillance device.

While the present invention has been disclosed in terms of the preferred embodiments in order to facilitate better understanding thereof, it should be appreciated that the invention can be embodied in various ways without departing from the principle of the invention. Therefore, the invention should be understood to include all possible embodiments and modifications to the shown embodiments which can be embodied without departing from the principle of the invention as set forth in the appended claims. For instance, the rotary bracket 38 may be retained to be panable by tow or more than three guide rollers, any other similar bearing members, or a combination thereof. The cover 6 may alternatively be of any shape other than a dome.

What is claimed is:

1. A surveillance camera device comprising:
a camera unit working to capture an image of a surveillance target and output an image signal indicative of the captured image;
a rotary bracket made of an annular plate serving to support said camera unit rotatably;
rotation guide members placed in contact with a periphery of said rotary bracket to guide rotation of said rotary bracket; and
a mount body on which said rotation guide member is mounted.

2. A surveillance camera device as set forth in claim 1, wherein said rotation guide members are implemented by at least one tension roller and a plurality of guide rollers.

3. A surveillance camera device as set forth in claim 1, wherein said rotary bracket has disposed thereon a pair of support arms diametrically opposed to each other, the support arms supporting said camera unit rotatably.
